(19) United States
(12) Patent Application Publication
(10) Pub. No.: US 2008/0166979 A1
(43) Pub. Date: Jul. 10, 2008

(54) System and method for controlling control unit drive frequency

(75) Inventor: David Eugene Brandon, Waterloo, IA (US)

Correspondence Address: DEERE & COMPANY, ONE JOHN DEERE PLACE, MOLINE, IL, 61265, US

(73) Assignee: Deere and Company

(21) Appl. No.: 11/651,392

(22) Filed: Jan. 9, 2007

(51) Int. Cl. H04B 15/00

(52) U.S. Cl. 455/77

(57) ABSTRACT

The invention relates to an electronics system with a radio and a electronic control unit (ECU). There is a need for preventing an electronics system from interfering with operation of the radio. The system includes a communication link communicating a tuned frequency message from the radio to the ECU. The system also includes a frequency controller for varying the control frequency as a function of the tuned frequency message, a bandwidth associated with the selected radio frequency, a bandwidth associated with the radio frequency noise harmonics, and an odd number integer. The frequency controller causes the control frequency to be between minimum and maximum values. Thus, the frequency controller receives the tuned frequency message and varies the control frequency its radio frequency noise harmonics do not significantly interfere with the tuned frequency of the radio.

### BACKGROUND

The present invention relates to a system and method for controlling the drive frequency of vehicle electronic units.

Current production vehicle electronics systems include one or more electronic functions connected by wire harnesses to electronic control units and a standard communications bus for communicating information to and from the electronic control units. In a known manner, the control units generate control instructions for one or more vehicle functions by executing appropriate known control algorithms.

The electronic control units generate square wave control signals which are transmitted by the wire harnesses and upon which the control instructions are superimposed. The square wave control signals typically have duty cycles or drive frequencies which vary from about 100 Hz to 500 KHz.

Electromagnetic emissions from such vehicle electronics systems and their electronic control units, while very low (and well within regulatory limits), can interfere with the operations of on-board radios (entertainment and business-band) on vehicles. This occurs, not because the emissions are of an excessively high level, but because the radio must be very sensitive in order to detect very weak radio signals. For example, high-voltage switching supplies (used in some vehicle control units) may make a number of frequencies within the AM radio band difficult to hear for all but the strongest stations. In the past this problem has been dealt with by expensive and time-consuming re-designs of the circuit board of the electronic controller, and/or by adding filtering components to reduce the controller emissions to an acceptable level.

The present invention relates to a system for controlling the drive frequency of vehicle electronic units so that radio frequency emissions from the units do not interfere with a radio on the vehicle.

### SUMMARY

Accordingly, an object of this invention is to provide vehicle electronic units which do not interfere with a radio on the vehicle.

A further object of this invention is to provide a vehicle electronic units which alters its drive frequency so that radio frequency emissions from the units do not interfere with a radio on the vehicle

These and other objects are achieved by the present invention, wherein an electronic system includes a radio tunable to receive a selected one of a plurality of radio frequency signals and to an electronic control unit (ECU) which emits a control signal having a control frequency having radio frequency noise harmonics. The system includes a communication link communicating a tuned frequency message from the radio to the ECU. The system also includes a frequency controller for varying the control frequency as a function of the tuned frequency message, a bandwidth associated with the selected radio frequency, a bandwidth associated with the radio frequency noise harmonics, and an odd number integer. The frequency controller causes the control frequency to be between minimum and maximum values. Thus, the frequency controller receives the tuned frequency message and varies the control frequency so that its radio frequency noise harmonics do not significantly interfere with the tuned frequency of the radio.

With this invention there is no need to iteratively modify the design of the electronic control unit, its circuitry or operation to attempt to reduce radio frequency emissions. The need is only to make sure the radio frequency noise is below certification limits and not at the radio operating frequency. Several radios (such as business-band concurrent with AM entertainment) can be handled at the same time by assuring the chosen drive frequency avoids each of the particular operating frequencies of any number of radios.

### BRIEF DESCRIPTION OF THE DRAWINGS

FIG. 1 is a schematic diagram of a vehicle electronics system including the present invention; and

FIG. 2 is logic flow diagram illustrating an algorithm executed by a processor unit of FIG. 1.

### DETAILED DESCRIPTION

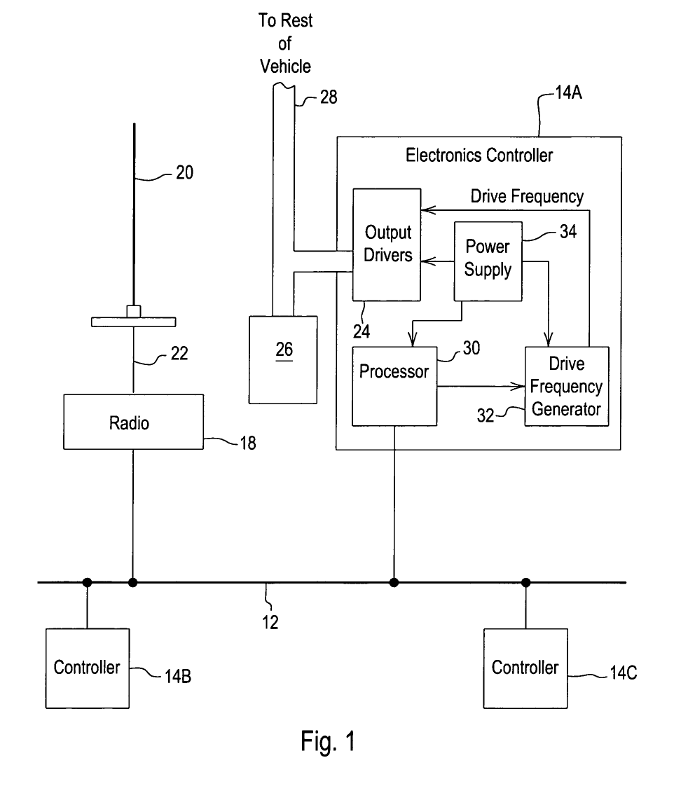

Referring to FIG. 1, a vehicle electronic control and communications network 10 includes a communications bus 12, to which are connected one or more electronic control units (ECU) 14A, 14B and 14C for controlling various vehicle functions (not shown), and a vehicle entertainment or business band radio receiver 18 which, in a known manner, can be tuned to different frequencies. The radio 18 is connected to an antenna 20 by a conventional coax cable 22.

Each ECU, as illustrated by ECU 14A, includes an output drive unit 24 which is connected to one or more electronic function driver units 26 via a wiring harness 28. ECU 14A also includes a processor unit 30 which is connected to the bus 12 and to a drive frequency generator unit 32. ECU 14A also includes and a power supply unit 34. Power supply unit 34 and output drive unit 24 are connected to drive frequency generator unit 32. In a known manner, the processor unit 30 generates control instructions for one or more vehicle function (not shown) by executing appropriate control algorithms, which algorithms form no part of the present invention.

According to the present invention, radio receiver 18 communicates a tuned frequency signal or message over bus 12 to the processor 30 of the ECUs 14. This tuned frequency signal indicates to the ECUs as to what frequency the radio receiver 18 is tuned.

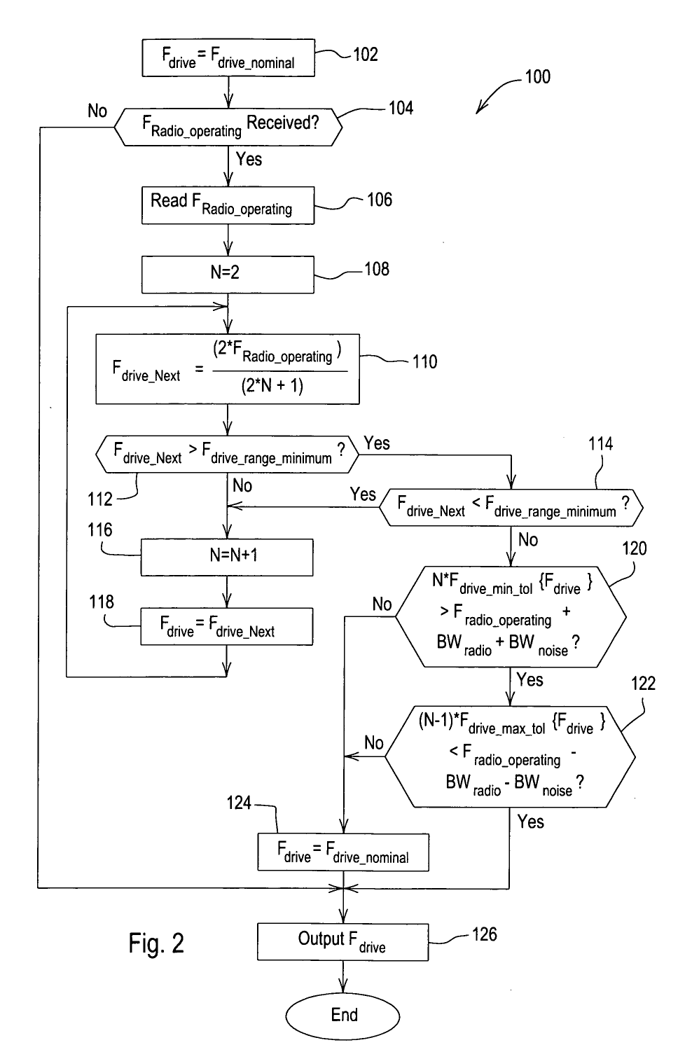

The processor 30 executes an algorithm 100 represented by the flow chart shown in FIG. 2. The conversion of this flow chart into a standard language for implementing the algorithm 100 described therein in a digital computer or microprocessor, will be evident to one with ordinary skill in the art. The flow chart includes terms or variables defined as follows.

BWₙₒᵢₛₑ—The bandwidth in terms of frequency of the noise source controlled by the drive frequency which is being coupled undesirably into the radio system.

BW_{radio}—The bandwidth in terms of frequency of the demodulator within the radio.

F_{drive}—The drive frequency determined by the algorithm.

F_{drive}_{_{—}}ₙₒₘᵢₙₐₗ—The default or base drive frequency.

F_{drive}_{_{—}}ₙₑₓₜ—The next drive frequency that would be evaluated.

F_{drive}_{_{—}}ₘᵢₙ_{_{—}}ₜₒₗ—A function to return the minimum frequency with all tolerancing that occurs for a particular drive frequency.

F_{drive}_{_{—}}ₘₐₓ_{_{—}}ₜₒₗ—A function to return the maximum frequency with all tolerancing that occurs for a particular drive frequency.

F_{drive}_{_{—}}_{range}_{_{—}}ₘᵢₙᵢₘᵤₘ—The lowest drive frequency for which the hardware will operate properly and hence the lowest that should be selected or allowed.

F_{drive}_{_{—}}_{range}_{_{—}}ₘₐₓᵢₘᵤₘ—The highest drive frequency for which the hardware will operate properly and hence the highest that should be selected or allowed.

F_{Radio}_{_{—}}_{operating}—The operating frequency of the radio usually the frequency of a particular station chosen by the operator.

N—The harmonic index number used to check a particular drive frequency for interference with the radio operating frequency.

Referring now to FIG. 2A, the algorithm begins at step 102 which sets a drive frequency value, F_{drive} equal to a stored nominal drive frequency value, F_{drive}_{_{—}}ₙₒₘᵢₙₐₗ. Step 104 directs the algorithm to step 124 if no radio frequency message is received by the processor 30, else to step 106 which reads the message and stores the radio current operating or tuned frequency as F_{Radio}_{_{—}}_{operating}.

Step 108 then sets a harmonic index value N equal to 2 so that the system will start with the lowest possible harmonic of the radio tuned frequency.

Step 110 then calculates a next drive frequency value, F_{drive}_{_{—}}ₙₑₓₜ, according to the equation: F_{drive}_{_{—}}ₙₑₓₜ=(2*F_{Radio}_{_{—}}_{operating})÷((2*N)+1). As a result, the frequency controller causes the control frequency to be a function of the selected radio frequency and an odd number integer.

Step 112 determines whether the F_{drive} next harmonic will yield a drive frequency above the minimum frequency which the drive hardware 32 can generate. If not, step increases the index N by 1 in step 116, sets F_{drive} equal to F_{drive}_{_{—}}ₙₑₓₜ and returns the algorithm to step 110. If yes, step 112 directs the algorithm to step 114.

Step 114 determines whether the F_{drive}_{_{—}}ₙₑₓₜ harmonic will yield a drive frequency below the maximum frequency which the drive hardware 32 can generate. If yes, step 114 directs control to step 116, else to step 120. Thus steps 112 and 114 operate to assure that the drive frequency generated by the algorithm will be between certain limits.

Step 120 determines whether this particular harmonic of the drive frequency, including minimum tolerances, will be above the noise and radio bandwidths above the operating frequency of the radio 18. Thus, step 122 determines if (N*F_{drive}_{_{—}}ₘᵢₙ_{_{—}}ₜₒₗ)>(F_{Radio}_{_{—}}_{operating}+BW_{radio}+BWₙₒᵢₛₑ). If no, step 120 directs control to step 124, else to step 122.

Step 122 determines whether the next lower harmonic of the drive frequency, including maximum tolerances, will be below the noise and radio bandwidths below the operating frequency of the radio 18. This, step 122 determines if ((N−1)*F_{drive}_{_{—}}ₘₐₓ_{_{—}}ₜₒₗ)>(F_{Radio}_{_{—}}_{operating}−BW_{radio}−BWₙₒᵢₛₑ). If no, step 120 directs control to step 124, else to step 126.

Step 124 resets the drive frequency value F_{drive} to the stored nominal drive frequency value, F_{drive}_{_{—}}ₙₒₘᵢₙₐₗ.

Step 126 outputs to drive signal frequency generator 32 the drive frequency value determined in either step 110 or step 124. Thus, the invention alters the drive frequency of the electronics producing the emissions as a function of the tuned frequency of the on-board radio or radios so that none of the emissions are within the particular bandwidth of the tuned radio operating frequency. In other words, the ECU operates as or includes a frequency controller for varying the selected frequency it outputs. The frequency controller receives a network message representing the tuned frequency of the radio, and the frequency controller varies the selected frequency as a function of the tuned frequency to cause the outputted radio frequency signal to have a frequency such that the outputted radio frequency signal does not interfere with the radio reception.

ECU 14C causes drive frequency generator unit 32 to supply to output driver unit 24 a control signal which has variable control frequency and a variable duty cycle.

Thus, this system provides the tuned or operating frequency of one or more radios to the electronics controls by a message transmitted across the on-board vehicle network. This message may be a voltage, current, frequency, duty-cycle or other measurable parameter proportional to the radio operating frequency with a resolution of 1 in 200 for AM stations and 1 in 1000 for FM stations is suitable.

The system then controls the control frequency of the control signal generated by the vehicle electronics, such as the high-voltage switching supply, to prevent the control signal or any of its harmonics from interfering with the radio's tuned frequency. This may be accomplished with a timer-counter within the microprocessor electronics programmed to generate a fixed frequency variable over a range. Or, other means may be used, such as switched frequency oscillators or voltage tuned oscillators. A particular controller could be programmed to calculate the desired frequency, or the desired frequencies could be calculated ahead of time and stored in a look-up table if calculation time is limited. Preferably, this calculation will account for noise bandwidth, radio bandwidth, radio detector type, radio channel spacing and other parameters to minimize interference.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

I claim:

1. In an electronic system having a radio tunable to receive a selected one of a plurality of radio frequency signals and to an electronic control unit (ECU) which emits a control signal having a control frequency having radio frequency noise harmonics, the system comprising:
a communication link communicating a tuned frequency message from the radio to the ECU, the tuned frequency message communicating to the ECU the selected radio frequency to which the radio is tuned; and
a frequency controller for varying said control frequency, the frequency controller receiving the tuned frequency message and varying the control frequency as a function of the tuned frequency so that the radio frequency noise harmonics do not significantly interfere with the tuned frequency of the radio.

2. The electronic system of claim 1, wherein:
the communication link comprises a bus connected to the radio and to the ECU.

3. The electronic system of claim 1, wherein:
the frequency controller varies the control frequency as a function of the tuned frequency message and a bandwidth associated with the selected radio frequency.

4. The electronic system of claim 1, wherein:
the frequency controller varies the control frequency as a function of the tuned frequency message, a bandwidth associated with the selected radio frequency, and a bandwidth associated with the radio frequency noise harmonics.

5. The electronic system of claim 1, wherein:
the frequency controller causes the control frequency to be a function of the selected radio frequency and an odd number integer.

6. The electronic system of claim 1, wherein:
the frequency controller causes the control frequency to be between minimum and maximum values.

7. In an electronic system having a radio tunable to receive a selected one of a plurality of radio frequency signals and to an electronic control unit (ECU) which emits a control signal having a control frequency having radio frequency noise harmonics, the system comprising:
a communication link communicating a tuned frequency message from the radio to the ECU, the tuned frequency message communicating to the ECU the selected radio frequency to which the radio is tuned; and
a frequency controller for varying said control frequency, the frequency controller receiving the tuned frequency message and varying the control frequency as a function of the tuned frequency so that the radio frequency noise harmonics do not significantly interfere with the tuned frequency of the radio, the frequency controller varying the control frequency as a function of the tuned frequency message, a bandwidth associated with the selected radio frequency, and a bandwidth associated with the radio frequency noise harmonics, and the frequency controller causes the control frequency to be a function of the selected radio frequency and an odd number integer.

8. The electronic system of claim 7, wherein:
the frequency controller causes the control frequency to be between minimum and maximum values.

9. In an electronic system having a radio tunable to receive a selected one of a plurality of radio frequency signals and to an electronic control unit (ECU) which emits a control signal having a control frequency having radio frequency noise harmonics, a method of controlling noise, comprising:
communicating a tuned frequency message from the radio to the ECU, the tuned frequency message communicating to the ECU the selected radio frequency to which the radio is tuned; and
varying said control frequency as a function of the tuned frequency so that the radio frequency noise harmonics do not significantly interfere with the tuned frequency of the radio.

10. The method of claim 9, further comprising:
varying the control frequency as a function of the tuned frequency message and a bandwidth associated with the selected radio frequency.

11. The method of claim 9, further comprising:
varying the control frequency as a function of the tuned frequency message, a bandwidth associated with the selected radio frequency, and a bandwidth associated with the radio frequency noise harmonics.

12. The method of claim 9, further comprising:
controlling the control frequency to be a function of the selected radio frequency and an odd number integer.

13. The method of claim 9, further comprising:
causing the control frequency to be between minimum and maximum values.
